(19) United States
(12) Patent Application Publication
(10) Pub. No.: US 2003/0024184 A1
(43) Pub. Date: Feb. 6, 2003

(54) Door frame with concealed intumescent material

(76) Inventors: William H. Orr JR., Anaheim, CA (US); Robert Lloyd Briggs SR., Rancho Cucamonga, CA (US); Robert Lloyd Briggs JR., Alta Loma, CA (US)

Correspondence Address: CHRISTIE, PARKER & HALE, LLP, P.O. BOX 7068, PASADENA, CA, 91109-7068, US

(21) Appl. No.: 10/208,517

(22) Filed: Jul. 30, 2002

Related U.S. Application Data
(60) Provisional application No. 60/308,895, filed on Jul. 31, 2001.

(51) Int. Cl. E06B 1/04

(52) U.S. Cl. 52/211

(57) ABSTRACT

An extruded door frame member for use with a fire-rated interior door has a chamber therein which opens to the exterior of the frame member proximate to the apex of a corner defined by a principle web of the member and a stop shoulder also defined by the member. That chamber can open to the exterior of the frame member either through the stop shoulder or through the principle web. The frame member can be configured for mounting, adjacent the chamber opening, a deformable member for at least partially covering the chamber opening in a desired manner.

### CROSS-REFERENCE TO RELATED APPLICATION

This application claims the priority of U.S. Provisional Patent Application No. 60/308,895 filed Jul. 31, 2001.

### FIELD OF THE INVENTION

This invention pertains to door frames for fire-rated interior doors. More particularly, it pertains to an extruded door frame which, in association with a door stop feature of the frame, includes an intumescent material in a substantially protected and unobtrusive location.

### BACKGROUND OF THE INVENTION

Uniform Building Code (UBC) Section 7.2 (1997) pertains to positive pressure requirements for doors having a 20 minute fire rating. Doors having such a rating are able to withstand a pressure differential of specified magnitude and direction across them for 20 minutes. In that regard, it is known to adhere intumescent material to the sides and top edges of a door frame for engagement with the generally flat sides and top edges of a closed door upon expansion of the intumescent material. An intumescent material is one which swells or expands when heated to a temperature above a specified temperature. Intumescent materials are used, as described above, to provide a pressure seal between a door frame and a closed door in the frame in the event of a fire in the vicinity of the door.

Placement of intumescent material on a door frame in the ways and locations heretofore known makes the material visible when the door is open. High visibility of the intumescent material may be inconsistent with the aesthetics desired for the door frame. Also, such placement of the intumescent makes it susceptible to wear or damage as people and things move through the doorway.

A need exists for an improved way to mount intumescent material in a door frame so the material is not readily visible and is protected from damage yet is capable of effectively engaging a door closed in the frame when the material expands in the presence of elevated temperatures.

### SUMMARY OF THE INVENTION

This invention addresses the need identified above. It does so by providing a door frame extrusion which includes a partially open yet substantially closed chamber for receipt of an appropriately shaped body of intumescent material. The chamber is located in the frame extrusion so that the opening to the chamber is not readily seen in use of the frame and so that intumescent material in the chamber is substantially protected during normal use of a door framed by the extrusion.

Generally speaking, the invention provides an extruded door frame member useful for defining a side or top of a finished interior doorway. The frame member includes a principal web and a stop shoulder. The stop shoulder is substantially perpendicular to the principal web and is located on the web at substantially a closed position of a door mounted in the doorway in use of the frame member. The stop shoulder and the web form a corner to accommodate an edge of a closed door in use of the frame member. The frame member defines therein a chamber proximate the corner. The Chamber has an opening from it to the exterior of the frame member proximate to the corner. An intumescent material in the chamber can expand through the opening when subjected to an elevated temperature.

### DESCRIPTION OF THE DRAWINGS

The above-mentioned and other features of the invention are set forth in the following description of the invention, which description is presented with reference to presently preferred and other embodiments of the invention and with reference to the accompanying drawings in which:

FIG. 1 is a cross-section view of a presently preferred extruded door frame member in which are shown in broken lines a wall partition supporting the frame member and a door in closed relation to the frame member;

FIG. 2 is an enlarged view of the portion of the frame member within area 2 of FIG. 1;

FIG. 3 is a view similar to that of FIG. 2 showing the manner of cooperation of expanded intumescent material with the flange of the adjacent bumper element to provide a pressure seal with the adjacent faces of a closed door.

FIG. 4 is a fragmentary cross-section view, similar to FIG. 2, showing coverage of intumescent material in the door frame member by a deformable element separate from an adjacent bumper element;

FIG. 5 is a fragmentary cross-section view, similar to FIG. 4, showing coverage of intumescent material in the door frame member by plural deformable elements; and

FIG. 6 is a fragmentary cross-section view, showing intumescent material in a different location in a door frame member in association with a deformable element separate from the bumper element.

### DESCRIPTION OF THE ILLUSTRATED AND OTHER FRAME MEMBER

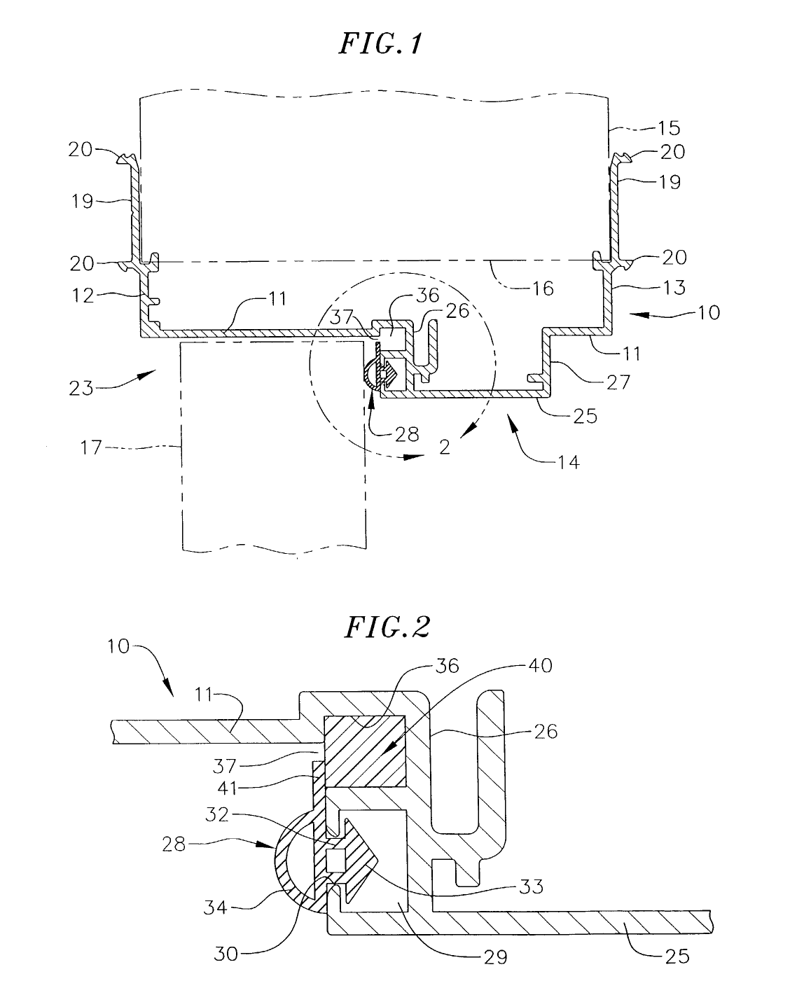

FIG. 1 is a cross-section view of a presently preferred interior door frame member 10 according to this invention. The cross-sectional characteristics of frame member 10 preferably are uniform along the length of the member. The frame member is made of metal and preferably is created by an extrusion process. As depicted, the frame member preferably is of generally U-shaped cross-section and includes a central web 11 which extends between and carries a pair of opposite side flanges 12,13. But for the presence of a door stop structure 14 defined in the web roughly centrally between side flanges 12,13, the exterior surface of web 11 is essentially planar. The side flanges of the frame member also are substantially planar and parallel to each other. The included angle between the web and each side flange preferably is a right angle.

FIG. 1 includes broken line representations of a wall partition 15 which roughly defines a part of a rough door opening 16, and of a door 17 hinged to a door frame defined by frame member 14 and by additional frame members like it. FIG. 1 is typical of a section through the door frame at essentially any location along its sides or along its top. As shown in FIG. 1, frame member 10 can be and preferably is mounted to and supported by partition 15 in opening 16. The dimensions of the frame member are coordinated with the thickness of partition 15 so that the partition fits snugly between the opposing faces of the frame members side flanges 12,13 distally from web 11. The frame member can be securely affixed to the partition by screws or other suitable fasteners into the partition through the distal portions 19 of the side flanges. Those fasteners can be covered and hidden by a trim plate (not shown) affixed to the frame member side flanges via retainer lips 20 extended outwardly from the frame member side flanges. Proper location of the partition between side flanges 12,13 can be aided by lugs 21 extending from the opposing faces of the side flanges; the lugs can abut the partition surface defining rough door opening 16 or, as shown, they can project into the partition material.

The web 11 of frame member 10 typically lies within rough opening 16 when the frame member has been mounted to a doorway-defining partition. The frame member defines a finished doorway opening 23. The details of the finished doorway opening include a stop surface and projection along the sides and across the top of the finished opening to define the closed position of door 17 in opening 23. In frame member 10, stop structure 14 defines the stop surface as a feature of the stop projection. To that end, the stop structure of frame member 10 can be in the form shown in FIGS. 1 and 2 in which, in cross-section, it resembles a channel having a web 25 interconnecting generally parallel side walls 26,27 connected distally from web 25 to frame member web 11. Web 11 can be and preferably is interrupted between the side walls of the stop structure; see FIG. 1.

The preferred use of frame member 10 is in the definition of an interior doorway. Door 17 can open from a closed position into or outwardly from the room or space with which it is associated. The side of the frame member toward which the door moves from its closed position can be called the interior side of the frame member. Consistent with FIG. 1, side flange 12 is an interior side flange and side wall 26 of the stop structure is an interior wall which is located about midway or so between side flanges 12,13.

In association with interior side wall 26, stop structure 14 defines a means for mounting a door stop bumper element 28 in cooperation with the closed position of door 17 in the frame member. In the frame member shown in the drawings, that bumper element mounting means includes a chamber 29 having a relatively narrow opening 30 from the chamber toward the closed position of door 17. The dimensions of the chamber and the width of opening 30 are coordinated with the width of a bumper element stem 32 having an enlarged head 33, the stem extending from the larger body 34 of a bumper strip preferably made of an elastomeric material having substantial inherent resiliency. The plane of opening 30 preferably is parallel to and adjacent to the door's closed position. The mounted position of the head of bumper element 28 in frame member 10 is toward side flange 12 from side wall 26, adjacent to but preferably spaced from web 11, and closely adjacent to web 25 but toward web 11. Bumper element 28 may be made by an extrusion process so that it is available in substantial lengths which can be cut to shorter lengths as desired. In the closed position of door 17, the head 34 of bumper element is partially compressed to form a sound (acoustic) seal with the door.

In support of the practice of this invention, frame member 10 provides means for mounting a quantity of intumescent material unobtrusively in the frame member for protection of the intumescent. The intumescent material is mounted in the frame member at a location in the frame member proximate to the corner formed at the junction of web 11 and the surfaces of the stop structure which face toward frame member flange 12. It is in that corner where an edge and adjacent surfaces of door 17 are accommodated when the door is in its closed position in doorway 23. The intumescent material preferably is carried in the frame member closely proximate to the apex of that corner. In the frame member shown in the drawings, the intumescent mounting means includes a chamber 36 in the stop structure, that chamber having an opening 37 from the chamber toward the outer surface of a closed door adjacent the junction of that door surface with a side or top surface of the door. More particularly, chamber 36 is located in the frame member so that its back surface, opposite opening 37, is defined by wall 26 and so that an edge of opening 37 is defined by the exterior surface of the principal web 11 of the frame member. Opening 37 is located between web 11 and bumper element 28. Thus, chamber 36 opens to the exterior of the frame member at the deepest part of the frame member corner. The cross-sectional shape of chamber 36 is defined to be similar to but slightly larger than the cross-sectional shape of a body 40 of intumescent material placed in the frame member at a selected time before installation of the frame member in doorway 16. That selected time preferably is a time in the manufacture of the frame member before shipment of the frame member from he manufacturer to a wholesaler, distributor or installer. Bumper element 28 can be and preferably is placed in the frame member at a similar time.

More particularly, as shown in FIG. 2, at least a portion of the face of the intumescent material 40 which opens to the door-facing side of stop 14 is covered by a relatively thin, deformable, strip-like element defined by a flange 41 which extends laterally from the body 34 of resilient bumper element 28. While FIG. 2 shows flange 41 extending partially across that face of the intumescent material toward web 11 of the frame member, the flange can extend to web 11, and so completely cover the intumescent material from view, if desired. The location of the intumescent material, proximate the corner formed by web 11 and stop structure 14, causes that material to be significantly protected from damage during normal use of the doorway. Coverage, fully or partially by flange 41, of the intumescent material both further protects the intumescent and hides it from view.

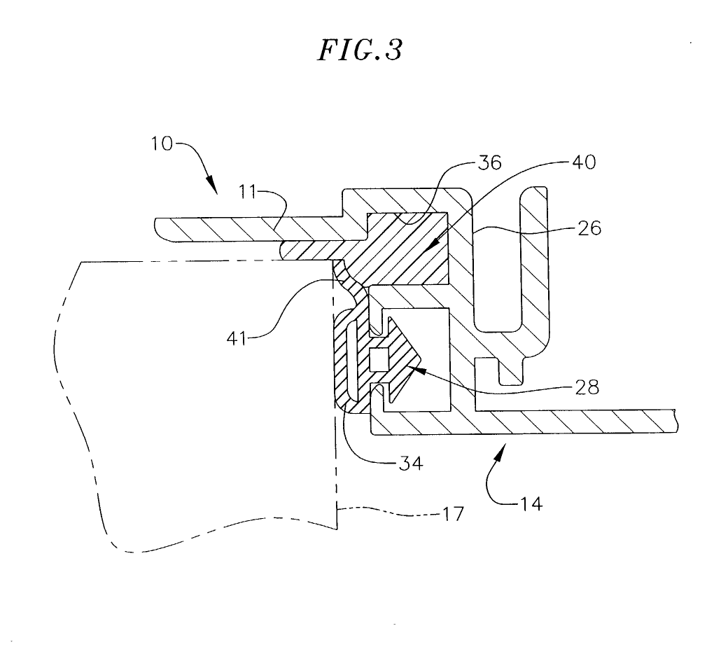

FIG. 3 illustrates a further benefit of the preferred practice of this invention. If, as preferred, flange 41 of bumper element 28 extends toward frame member web 11 (i.e., away from the finished doorway opening) across the face of the intumescent material which otherwise would be exposed to the exterior of its receiving chamber 36, deformation of the resilient flange 41 in response to swelling of the intumescent material assists in providing an effective pressure seal with a closed door 17 in the event of a fire. The portion of flange 41 which normally overlies a face of the intumescent material in chamber 36 is moved (deflected) by the expanding intumescent material into contact with the adjacent major surface of the closed door. The engagement of the deflected flange 41 with door 17 aids in withstanding the specified pressure differential across the closed door for the specified time.

Flange 41 aids in a further way in establishing the desired door pressure seal as the intumescent material expands. When heated to its expansion temperature, intumescent material expands in generally uncontrolled directions unless directed in its expansion. Obviously, the metal walls of chamber 36 cause the intumescent to expand through chamber opening 37, after which the intumescent further expands. Once bumper element flange 41 has engaged closed door 17 in the manner described (see FIG. 3), further expansion of the intumescent is directed into the gap between frame member web 11 and the adjacent door top or side surface. A maximum amount of expanded intumescent material is directed into that gap where its presence more effectively creates the desired pressure seal.

Acceptable intumescent materials are available from several sources in various types and sizes. A presently preferred intumescent material is type FS3003 black “soft puff” INTUMET intumescent material obtainable from Zero International, 415 Concord Avenue, Bronx, N.Y. 10455-4890. Intumescent product having dimensions of 0.180 inches wide by 0.150 inches high is preferred; the corresponding dimensions of chamber 36 are slightly greater to enable axial insertion of the intumescent into the chamber. INTUMET Type FS 3003 intumescent material begins to expand at 250° F. (121° C.) and can expand to 20 times its initial volume. That intumescent, when expanded, can resist a pressure differential of 27 psi across it for the desired time.

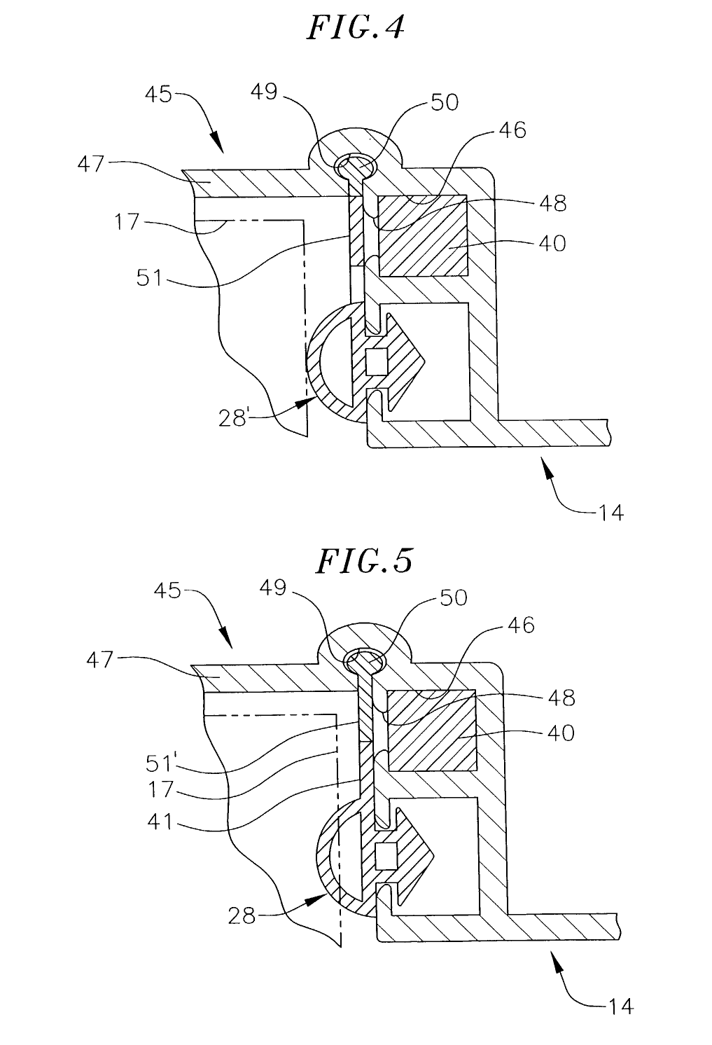

FIGS. 4, 5 and 6 depict other door frame element profiles according to this invention in which bodies of intumescent material are housed in chambers within the members in locations proximate the corner defined by the frame member's principle web 11 and the stop structure 14. Those Figures also show other ways in which deformable elements can cooperate with the openings to the corner areas from the intumescent housing chambers.

FIGS. 4 and 5 shows a door frame member 45 in which an intumescent housing chamber 46 is located in the member in substantially the same location as chamber 36 occupies in frame member 10, i.e., in the corner between web 47 of member 45 and stop structure 14 with the opening 48 from chamber 46 facing along web 46. Substantially just outside chamber 46, the frame member defines a relatively small chamber 49 which opens through web 47. Chamber 49 is contoured to cooperate with a mounting feature, such as a rounded edge bead 50, of an elongate resiliently deformable element 51 which preferably is of stip-like nature. The cooperation of chamber 49 with the mounting feature of element 51 is adequate to hold the element in place in member 45. In a finished frame member 45, element 51 is mounted to the frame member via chamber 49 and extends from that chamber across opening 48 from intumescent chamber 46. Element 51 can overlie all of the area of opening 48 (see FIG. 4) or it can overlie a portion of that area which is adjacent to web 46 (see FIG. 5)and element 51′ thereof. Where the deformable element covers all or substantially all of the area of opening 48, it can be used in association with a bumper element 28′ which is like bumper element 28 except that element 28′ has no lateral flange 41, as shown in FIG. 4. Deformable element 51′ can be used with bumper element 28 (FIG. 5) or with bumper element 28′, as desired. The manner in which deformable elements 51 and 51′ move (deform) and cooperate with the adjacent major surface of a closed door 17 will be apparent from an examination of FIG. 3.

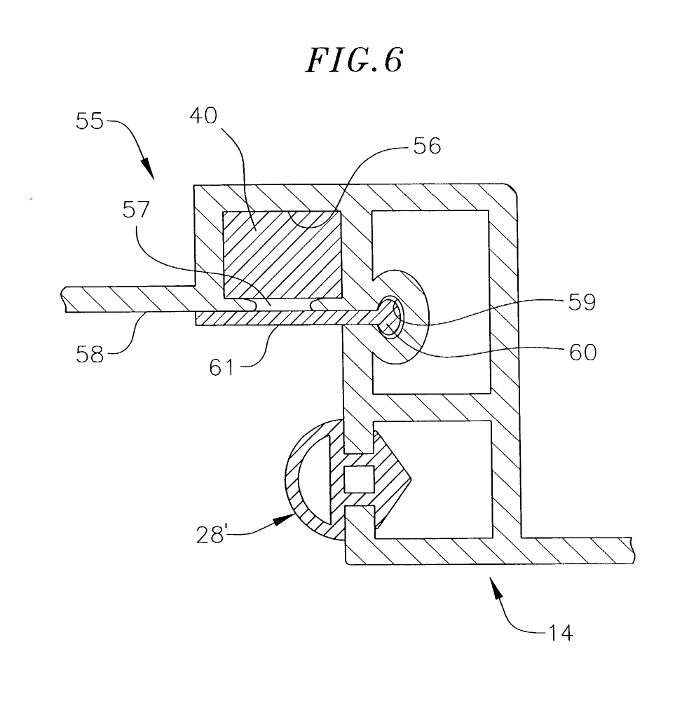

FIG. 6 depicts another door frame member 55 which has a profile configured to define an intumescent receiving chamber 56 which has an opening 57 through the principle web 58 of that member in the corner formed with stop structure 14. That is, chamber 56 opens through the plan of the substantially flat exterior surface of web 58. Frame member 55 also is profiled to define a relatively small chamber 59 which opens to the corner along the outer surface of principal web 58 and which receives and retains a mounting feature, such as an edge bead 60, of a deformable element 61 which be like either of deformable elements 51 or 51′. The preferably flat major portion of deformable element 61 can overly all of a selected portion of the area of opening 57 from intumescent chamber 56. Deformable element 61 preferably is used in frame member 55 in combination with a flangeless bumper element such as bumper element 28′. When FIG. 6 is considered in combination with FIG. 3, it will be seen that deformable element is arranged to move into contact with a side or top edge surface of a closed door in response to expansion of intumescent material in chamber 56 in use of frame member 55.

The accompanying drawings depict presently preferred and other structural arrangements and relations for practice of this invention. Other structural arrangements and relations may be used to practice the invention. Intumescent material in forms other than bars of square or rectangular cross-section may be used with corresponding adjustment of the cross-sectional shape of the intumescent mounting chamber. As an example, round rods of intumescent material can be used in receiving chambers of round or substantially round profile. The general nature of the stop structure need not be generally rectangular as shown in the drawings. The basic requirement of a door stop, in a frame member for defining the sides and top of a finished doorway, is to define a shoulder or the like substantially parallel to the adjacent major face of a door closed against the stop. Such a shoulder is defined in frame member 10, e.g., by the structure of the member defining and adjacent to opening 30 from the chamber which receives the head 33 of gasketing bumper element 28. To the right of that portion of stop structure 14 which defines that shoulder, the stop structure may be rounded or gradually faired into web 11 toward side flange 13. Also, different flanged and unflanged bumper elements can be used. If desired, bumper elements having substantially no body, but including a lateral flange at least partially covering a face of an adjacent intumescent material body, can be used. In other instances, the frame member may include no bumper element while locating the intumescent material in a chamber in the frame member at or proximate to the junction of the stop shoulder with the principal web of the frame member. Other variations of the described structure within the cope and substance of the invention may occur to workers skilled in the relevant art. Thus, the foregoing description and the accompanying drawings should not be read to describe all forms by which this invention may be practiced structurally or procedurally.

What is claimed:

1. An extruded door frame member useful for defining a side or top of a finished interior doorway, the frame member including a principal web, a door stop shoulder substantially perpendicular to the principal web at a location in the principal web which is at substantially a closed position of a door mounted in the doorway in use of the frame member, the stop shoulder and the principal web forming a corner to accommodate an edge of a closed door in use of the frame member, the frame member defining therein a chamber proximate the corner, the chamber having an opening therefrom to the exterior of the frame member proximate the corner, and an intumescent material in the chamber expandable through the opening when subjected to elevated temperatures.

2. A door frame member according to claim 1 including a deformable element mounted to the frame member adjacent the chamber and extending at least partially across the chamber opening.

3. A door frame member according to claim 2 in which the deformable element is defined by an elastomeric material.

4. A door frame member according to claim 2 in which the deformable element is strip-like in nature.

5. A door frame member according to claim 2 in which the deformable element is mounted adjacent the boundary of the chamber opening which is away from the principal web.

6. A door frame member according to claim 5 in which the deformable element is a feature of a resilient door bumper element carried in the stop shoulder.

7. A door frame member according to claim 6 in which the deformable element is defined as a lateral flange of the bumper element.

8. A door frame member according to claim 2 in which the deformable element is mounted adjacent the boundary of the chamber opening which is proximate the principal web.

9. A door frame member according to claim 2 in which the chamber opening is defined through the stop shoulder and faces along the principal web.

10. A door frame member according to claim 9 in which the deformable element is mounted adjacent the chamber opening which is away from the principal web.

11. A door frame member according to claim 9 in which the deformable element is mounted adjacent the boundary of the chamber opening which is proximate the principal web.

12. A door frame member according to claim 2 in which the chamber opening is defined through the principal web adjacent the stop shoulder.

13. A door frame member according to claim 1 in which the the chamber opening is through the stop shoulder.

14. A door frame member according to claim 1 in which the chamber opening is through the principal web.

15. An extruded interior door frame member which includes a principal web and a stop shoulder disposed substantially perpendicular to the principal web forming a corner with the web, the member defining a chamber having an opening therefrom proximate the chamber and in which a body of intumescent material can be housed.

16. A door frame member according to claim 15 in which the chamber opens through the stop shoulder and a boundary of the opening from the chamber is substantially at the principle web.

17. A door frame member according to claim 15 in which the chamber opens through the principal web.
